(19) United States
(12) Patent Application Publication
(10) Pub. No.: US 2003/0151264 A1
(43) Pub. Date: Aug. 14, 2003

(54) Dummy trim with an improved resistance to pull

(76) Inventor: Mu-Lin Shen, Tainan (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/073,648

(22) Filed: Feb. 11, 2002

(51) Int. Cl. E05B 15/02

(52) U.S. Cl. 292/357

(57) ABSTRACT

A dummy trim comprises a mounting plate to be fixed to a door, a spindle holder mounted to the mounting plate and including a peripheral wall, a spindle including a first end mounted in the peripheral wall of the spindle holder, and a lever securely attached to a second end of the spindle to move therewith. The first end of the spindle includes a slot having an edge facing the lever. The peripheral wall of the spindle holder includes an integral stop extending into the slot of the spindle and abutting against the edge of the slot.

### BACKGROUND OF THE INVENTION

1. Field of the Invention

The present invention relates to a dummy trim with an improved resistance to pull.

2. Description of the Related Art

FIG. 5 of the drawings illustrates a conventional dummy trim that is mounted to a door 10 for pull only. Namely, the dummy trim provides no locking function. The dummy trim comprises a spindle holder 25 to be fixed to a door 10, a spindle 23 having an end held by the spindle holder 25, a rose 22, and a lever 21 securely attached to the other end of the spindle 23. A user may pull the lever 21 for opening the door 10. When engaging the spindle 23 and the spindle holder 25, both of them are drilled to form aligned radial holes 31 and 32, and a screw or pin 30 is inserted into the radial holes 31 and 32 to thereby secure the spindle 23 and the spindle holder 25 together. A protective sleeve 24 may be mounted around the spindle holder 25. However, the pulling force applied to the lever 21 exerts a shear force to the pin 30 and thus loosens the spindle 23 after a period of time. Further, drilling of the radial holes 31 and 32 and insertion of the pin 30 are troublesome and cause an increase in the cost.

### SUMMARY OF THE INVENTION

An object of the present invention is to provide dummy trim with an improved resistance to pull.

A dummy trim in accordance with the present invention comprises a mounting plate to be fixed to a door, a spindle holder mounted to the mounting plate and including a peripheral wall, a spindle including a first end mounted in the peripheral wall of the spindle holder, and a lever securely attached to a second end of the spindle to move therewith. The first end of the spindle includes a slot having an edge facing the lever. The peripheral wall of the spindle holder includes an integral stop extending into the slot of the spindle and abutting against the edge of the slot.

Other objects, advantages, and novel features of the invention will become more apparent from the following detailed description when taken in conjunction with the accompanying drawings.

### BRIEF DESCRIPTION OF THE DRAWINGS

FIG. 1 is a fully exploded perspective view of a dummy trim in accordance with the present invention.

FIG. 2 is an exploded perspective view of the dummy trim in accordance with the present invention and a door to which the dummy trim is mounted.

FIG. 3 is a sectional view of the dummy trim in accordance with the present invention and the door.

FIG. 4 is a sectional view illustrating a pressing procedure for manufacturing the dummy trim in accordance with the present invention.

FIG. 5 is a sectional view of a door and a conventional dummy trim.

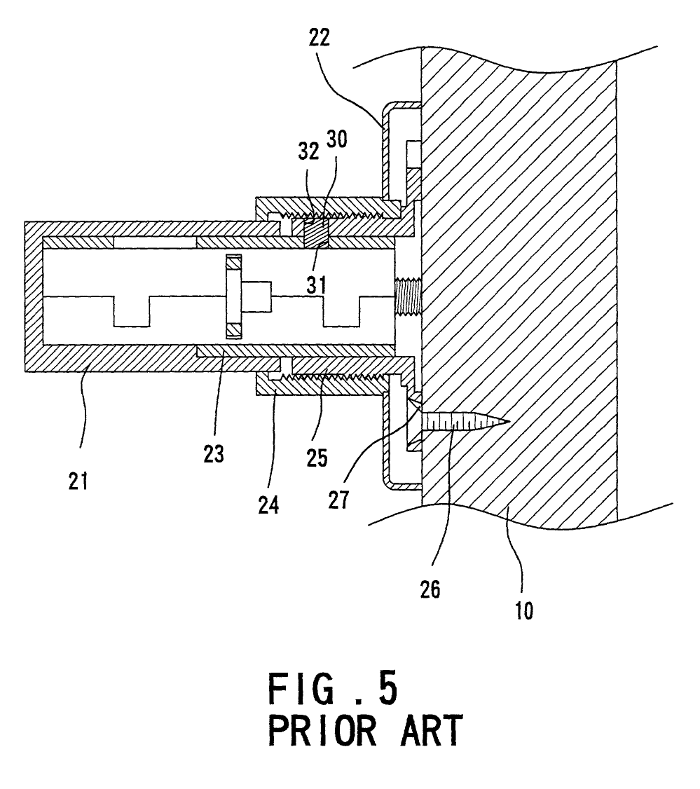

### DETAILED DESCRIPTION OF THE PREFERRED EMBODIMENT

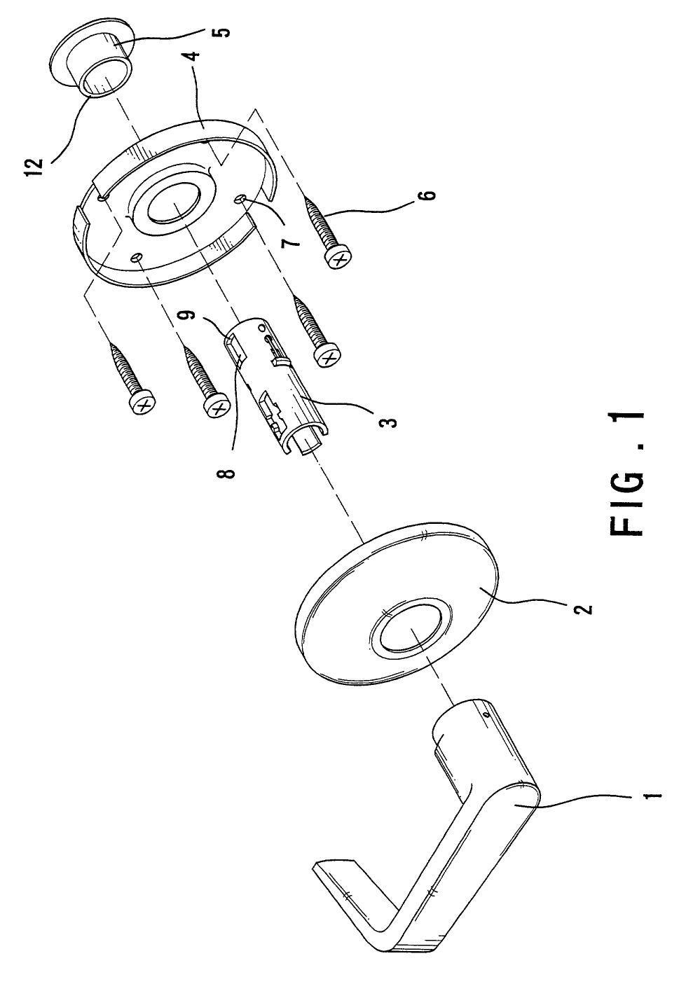

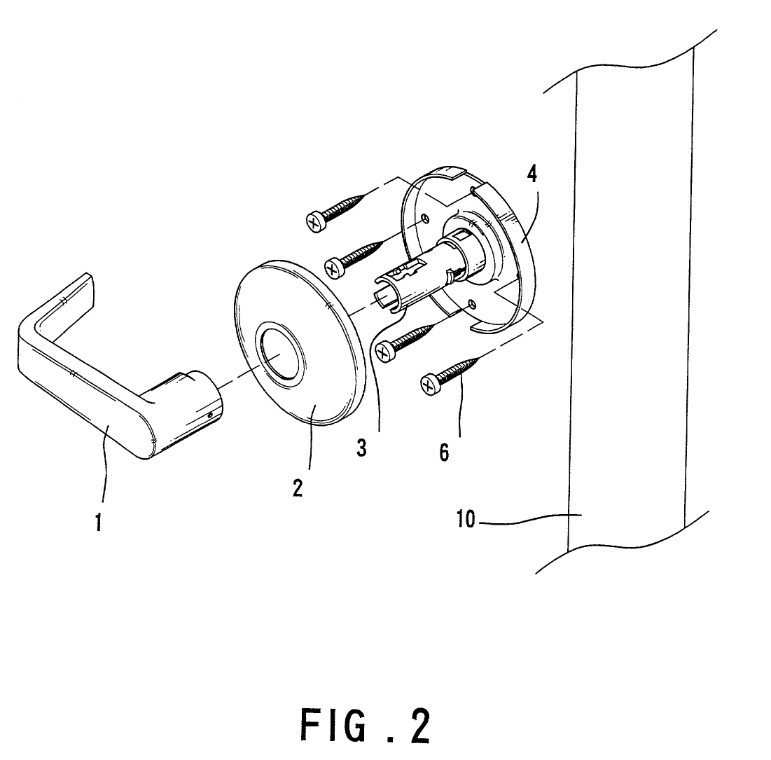

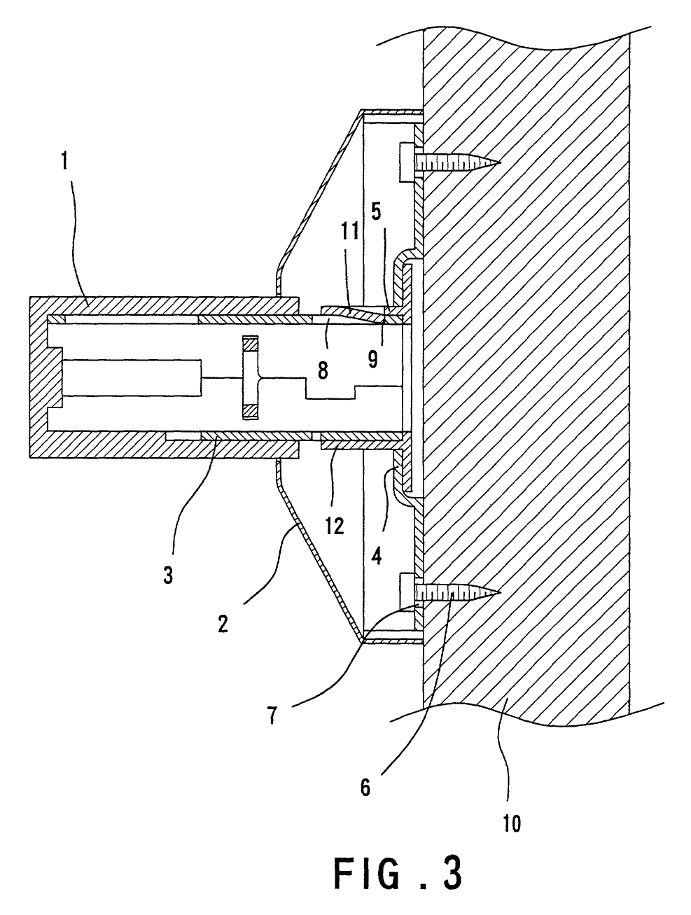

Referring to FIGS. 1 and 2, a dummy trim in accordance with the present invention generally comprises a lever 1, a spindle 3, a mounting plate 4, and a spindle holder 5. The spindle holder 5 is fixed to the mounting plate 4 and includes a peripheral wall 12. The mounting plate 4 is fixed to a door 10. Fasteners 6 are extended through holes 7 in the mounting plate 4 and into the door 10, best shown in FIG. 3.

Referring to FIGS. 1 and 3, the spindle 3 includes a slot 8 in an end thereof that is received in the peripheral wall 12 of the spindle holder 5. The lever 1 is secured to the other end of the spindle 3 to move therewith.

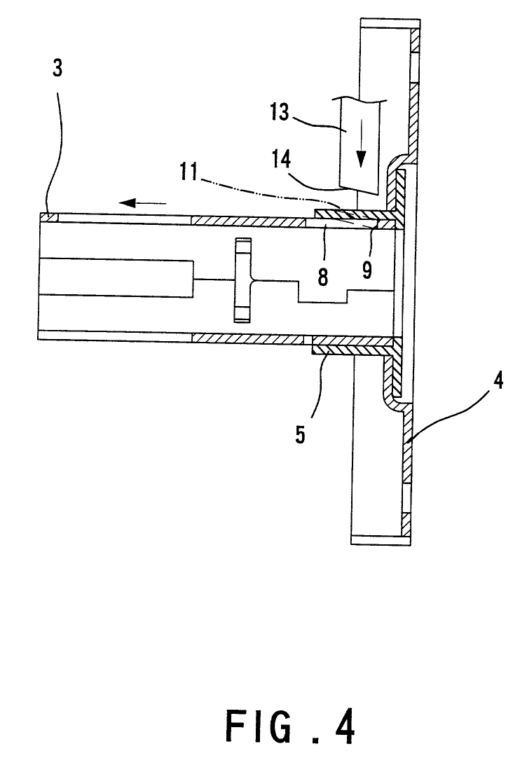

Referring to FIG. 4, in manufacture, the peripheral wall 12 of the spindle holder 5 is pressed inward by a punch member 13 in a position that aligns with the slot 8, thereby forming an inclined integral stop 11 that extends into the slot 8 of the spindle 3 and that abuts against an edge 9 (FIG. 1) of the slot 8 that faces the lever 1. By such an arrangement, as illustrated in FIG. 3, when the lever 1 is pulled, the spindle 3 is stopped by the integral stop 11 that is still integral with the spindle holder 5 after the pressing procedure. The resistance to pull is increased when compared with the conventional design using a pin 30 to secure the spindle 23 and the spindle holder 25 together.

Preferably, the punch member 13 has an inclined bottom 14 that declines toward the mounting plate 4, as shown in FIG. 4. This avoids unnecessary deformation of the spindle 3 and the spindle holder 5 after pressing.

A rose 2 may be mounted to enclose the mounting plate 4, the fasteners 6, and the spindle holder 5, thereby providing an aesthetically pleasing appearance.

Although the invention has been explained in relation to its preferred embodiment, it is to be understood that many other possible modifications and variations can be made without departing from the scope of the invention as hereinafter claimed.

What is claimed is:

1. A dummy trim comprising:
a mounting plate adapted to be fixed to a door;
a spindle holder mounted to the mounting plate and including a peripheral wall;
a spindle including a first end mounted in the peripheral wall of the spindle holder and a second end, the first end of the spindle including a slot; and
a lever securely attached to the second end of the spindle to move therewith;
the slot of the spindle having an edge facing the lever;
the peripheral wall of the spindle holder including an integral stop extending into the slot of the spindle and abutting against the edge of the slot.

2. The dummy trim as claimed in claim 1, wherein the integral stop is formed by means of pressing the peripheral wall of the spindle holder in a position aligning with the slot.

3. The dummy trim as claimed in claim 2, wherein the integral stop is inclined.
